(19) United States
(12) Patent Application Publication
(10) Pub. No.: US 2016/0379228 A1
(43) Pub. Date: Dec. 29, 2016

(54) UNIFIED PREDICTIVE RETAIL ECO- SYSTEM FOR GENERATING PREDICTIONS ACROSS A RANGE OF PRODUCTS

(71) Applicant: Anand GIRDHARILAL KATAKWAR, Indore (IN)

(72) Inventor: Anand GIRDHARILAL KATAKWAR, Indore (IN)

(21) Appl. No.: 15/194,387

(22) Filed: Jun. 27, 2016

(30) Foreign Application Priority Data
Jun. 27, 2015 (IN) 2465/MUM/2015

(51) Int. Cl. G06Q 30/02

(52) U.S. Cl. CPC G06Q 30/0202

(57) ABSTRACT

Disclosed is a method and system for generating predictions for customers for a range of products in retail sector. The method comprises classifying a product based upon exact values of a decision making feature set to generate a product buy point; b) associating the product to the product buy point and to a number of price ranges; c) partitioning the product buy point into as many affordability partitioned product buy points as the number of price ranges; d) computing a seasonality vector and a frugality vector for the product and for the product buy point based upon an actual sale record of the product; f) unifying the customer preference data from the plurality of sources and generating a customer product matrix; and h) applying a singular vector decomposition technique and a reconstitution technique for find out positive predictions.

### TECHNICAL FIELD

The present subject matter described herein, in general, relates to a method of generating predictions across a range of products.

### BACKGROUND

Content based systems are known and are based on products or items and their properties, wherein the details of the products are stored in a database along with their corresponding properties. Similarly, user data can be compiled to form multiple user profiles by monitoring the activity of users on the internet and storing the information pertaining to the products that the users purchase or have rated. These content based systems focus on the properties of products, which are compared with the vast number of user profiles to arrive upon predictions based on a similarity between the already purchased products by a user with other products having similar properties.

Collaborative-Filtering systems focus on the relationship between different Users and products. Similarity of products is determined by the similarity of the buying behavior of those products by the users who have bought them.

### SUMMARY

Before the present systems and methods are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for generating predictions across a range of products and the concepts are further described below in the detailed description. This summary is not intended to identify essential features of the claimed subject matter nor is it intended for use in detecting or limiting the scope of the claimed subject matter.

In one implementation, a method for generating predictions for customers for to range of products in a retail sector is disclosed. The method comprises at classifying a product based upon exact values of a decision making feature set to generate a product buy point, wherein the product buy point is stored as a record; b) associating the product to the product buy point and to a number of affordability price ranges; c) partitioning the product buy point into as many affordability partitioned product buy points as the number of affordability price ranges; d) computing a seasonality vector and a frugality vector for the product and for the product buy point based upon an actual sale record of the product, wherein the seasonality vector is indicative of a time frame or seasons, and wherein the frugality vector is a discount constraint on the product or customer; e) receiving customers preference data for the product from a plurality of sources; f) unifying the customer preference data from the plurality of sources; g) generating a customer product matrix based upon the unified customer preference data of the customers and the affordability partitioned product buy points, wherein the customer product matrix is generated by applying an evolution parameter, in addition to the frugality fraction on the unified customer preference data, wherein the evolution parameter is indicative of a customer's changing buying behavior over a period of time and frugality fraction is the weight defined for the discounting percentage present in the sale records) applying a singular vector decomposition technique and a reconstitution technique to the customer product matrix to obtain non zero values of the customer product matrix, wherein the nonzero values are indicative of positive predictions for the affordability partitioned product buy points for a given customer in the customer product matrix.

In one implementation, a system for generating predictions for customers for a range of products in a retail sector is disclosed. The system comprises a processor and a memory coupled to the processor, wherein the processor is capable for executing programmed instructions stored in the memory to a) classify a product based upon exact values of a decision making feature set to generate a product buy point, wherein the product buy point is stored as a record; b) associate the product to the product buy point and to a number of price ranges; c) partition the product buy point into as many partitioned buy points as the number of price ranges; d) compute a seasonality vector and a frugality vector for the product and for the product buy point based upon an actual sale record of the product, wherein the seasonality vector is indicative of a time frame or seasons, and wherein the frugality vector is a discount constraint on the product or customer; e) receive customers preference data for the product from a plurality of sources; f) unify the customer preference data from the plurality of sources; g) generate a customer product matrix based upon the unified customer preference data of the customers and the partitioned buy points, wherein the customer product matrix is generated by applying an evolution parameter on the unified customer preference data, wherein the evolution parameter is indicative of a customer's changing buying behavior over a period of time; and h) apply a singular vector decomposition technique and a reconstitution technique to the customer product matrix to obtain non zero values of the customer product matrix, wherein the non-zero values are indicative of positive predictions for the partitioned buy points for a given customer in the customer product matrix.

In one implementation, a non-transitory computer readable medium embodying a program executable in a computing device for generating predictions for customers for a range of products in a retail sector. The program comprising a) a program code for classifying a product based upon exact values of a decision making feature set to generate a product buy point, wherein the product buy point is stored as a record; b) a program code for associating the product to the product buy point and to a number of price ranges; c) a program code for partitioning the product buy point into as many partitioned buy points as the number of price ranges; d) a program code for computing a seasonality vector and a frugality vector for the product and for the product but point based upon an actual sale record of the product, wherein the seasonality vector is indicative of a time frame or seasons, and wherein the frugality vector is a discount constraint on the product or customer; e) a program code for receiving customers preference data for the product from a plurality of sources; f) a program code for unifying the customer preference data from the plurality of sources; g) a program code for generating a customer product matrix based upon the unified customer preference data of the customers and the partitioned buy points, wherein the customer product matrix is generated by applying an evolution parameter on the unified customer preference data, wherein the evolution parameter is indicative of a customer's changing buying behavior over a period of time; and h) a program code for applying a singular vector decomposition technique and a reconstitution technique to the customer product matrix to obtain non zero values of the customer product matrix, wherein the non-zero values are indicative of positive predictions for the partitioned buy points for a given customer in the customer product matrix.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure. However, the disclosure is not limited to the specific methods and apparatus disclosed in the document and the drawings.

The detailed description is described with reference to the accompanying figures. The same numbers are used throughout the drawings to refer like features and components.

FIG. 1 illustrates an architecture of a retail eco-system in accordance with an embodiment of the present subject matter;

FIG. 2 illustrates a method of prediction generation in a unified predictive retail eco-system in accordance with an embodiment of the present subject matter;

FIG. 3 illustrates processing of a customer record for prediction generation in accordance with an embodiment of the present subject matter;

FIG. 4 illustrates processing of product record for prediction generation in accordance with an embodiment of the present subject matter;

FIG. 5 illustrates processing of customer preference or sale record for prediction generation in accordance with an embodiment of the present subject matter;

FIG. 6 illustrates classification of products into buy decision making feature sets in accordance with an embodiment of the present subject matter;

FIG. 7 illustrates the formation of a product buy space of a single feature set in accordance with an embodiment of the present subject matter;

FIG. 8 illustrates the formation of a universal product buy space in accordance with an embodiment of the present subject matter;

FIG. 9 illustrates affordability partitioning of a product buy space in accordance with an embodiment of the present subject matter;

FIG. 10 illustrates a Customer×Product (C×P) matrix data structure in accordance with an embodiment of the present subject matter;

FIGS. 11 to 14 illustrate a configuration interface for adapters, feature sets, affordability, seasonality, frugality, and evolution vectors/parameters in accordance with an embodiment of the present subject matter;

FIGS. 15A, B, and C illustrate a method of finding a customer's N choice products and M predicted products with seasonality and frugality considerations in accordance with an embodiment of present subject matter;

FIG. 16A illustrates an OmniChannel Predictive campaigning application of the present subject matter;

FIG. 16B is an illustration of Frugality based campaign application of the present subject matter;

FIG. 16C shows seasonal campaigning application of present subject matter;

FIG. 17A shows a web store in accordance with an embodiment of present subject matter;

FIG. 17B illustrates the web store being transformed as per individual choice and predict store having a seasonal view of a customer's personal store in accordance with an embodiment of present subject matter;

FIG. 17C shows another user's personal store to illustrate that every customer's store is different and auto generated as per the choice and predict products of that customer in accordance with an embodiment of present subject matter;

FIGS. 18A,B, and C show a mobile application depicting a customer specific store in accordance with an embodiment of present subject matter;

FIG. 19 shows feature sensitivity analysis application that shows the relative importance of all the different values of the feature in accordance with an embodiment of present subject matter; and

FIG. 20 shows a network implementation of a system for generating predictions for customers for a range of products in a retail sector in accordance with an embodiment of present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

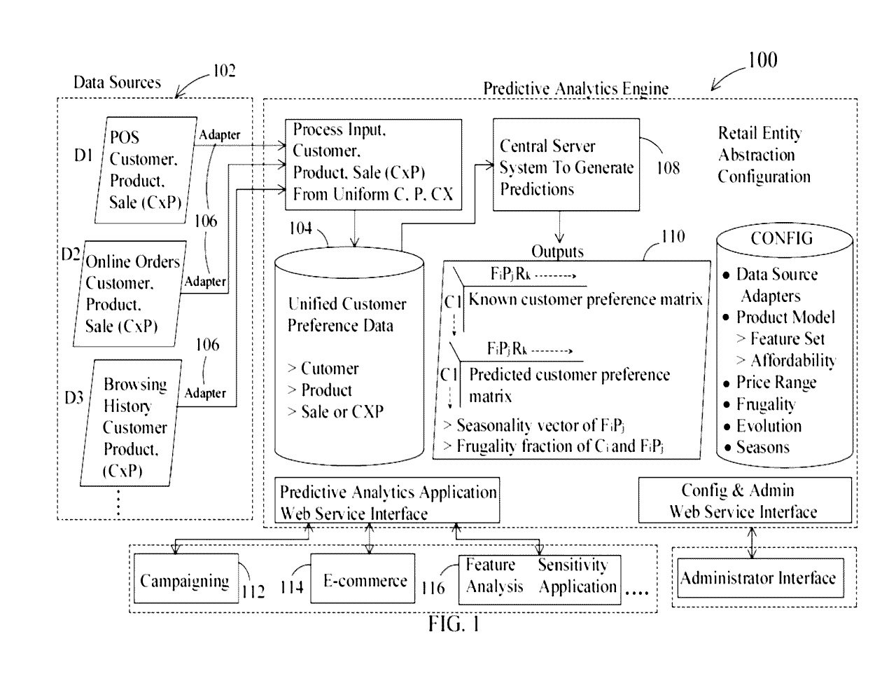

FIG. 1 illustrates architecture of a retail eco-system 100 in accordance with an embodiment of the present subject matter. As shown in FIG. 1. data sources 102 D1, D2, D3, and so on present in N weighted data sources 102 can be used for constructing a unified customer preference data 104. A different weight is assigned to each of these data sources D1, D2 D3, and so on, depending on the strength of the customer preference data present in each data source 102. For example, a maximum weight of 1 may be assigned to a data source if an implicit liking of a customer resulted in product being bought. In other words, a maximum weight of one may be assigned to an actual sale of a product; a lesser weight can be assigned to an item added to a shopping cart but not purchased, and a least weight may be assigned to an item in the browsing history of a user.

In one implementation, an adapter 106 transmits the data from these N data sources to a central server 108. The central server is responsible for the storage of all this data and processing and performing predictive analytics on the unified customer preference data. In one implementation, the output of the prediction generation process is stored on a server system 110. In one implementation, the server system may also store web servers or any other application servers such as email servers. As shown in FIG. 1, this output or the prediction data may be used in several applications such as campaigning 112, e-commerce 114, feature sensitivity analysis application 116, and the like. It is to be understood that the scope of the present subject matter is not limited to these applications.

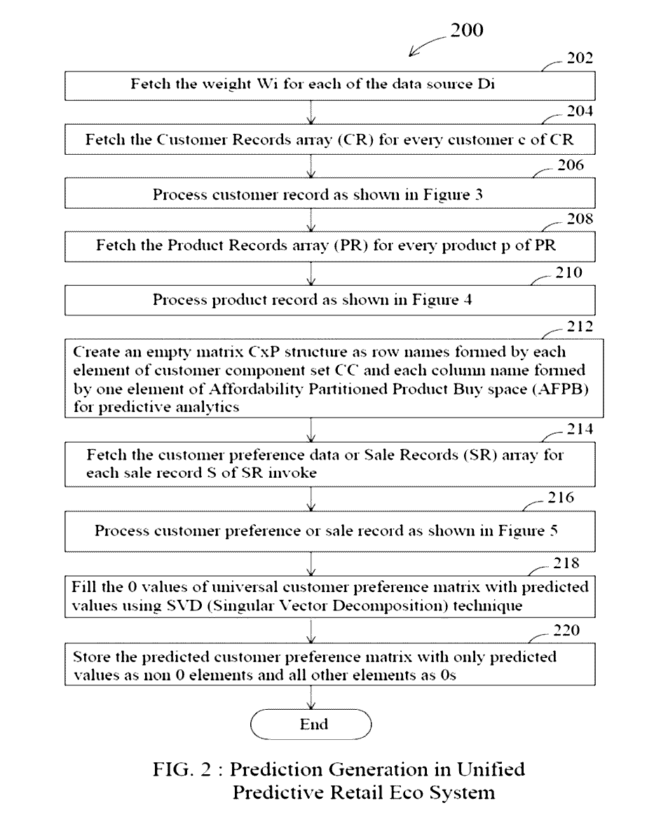

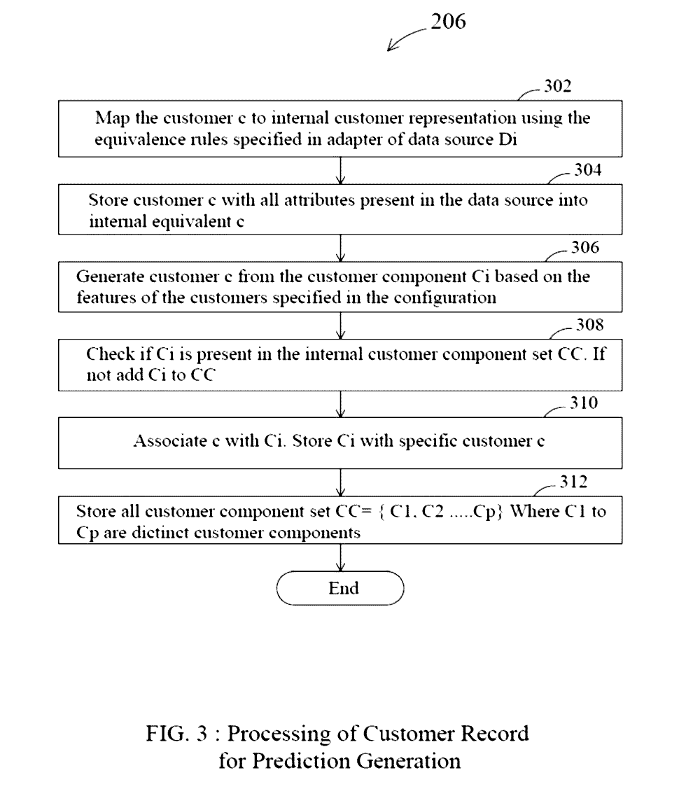

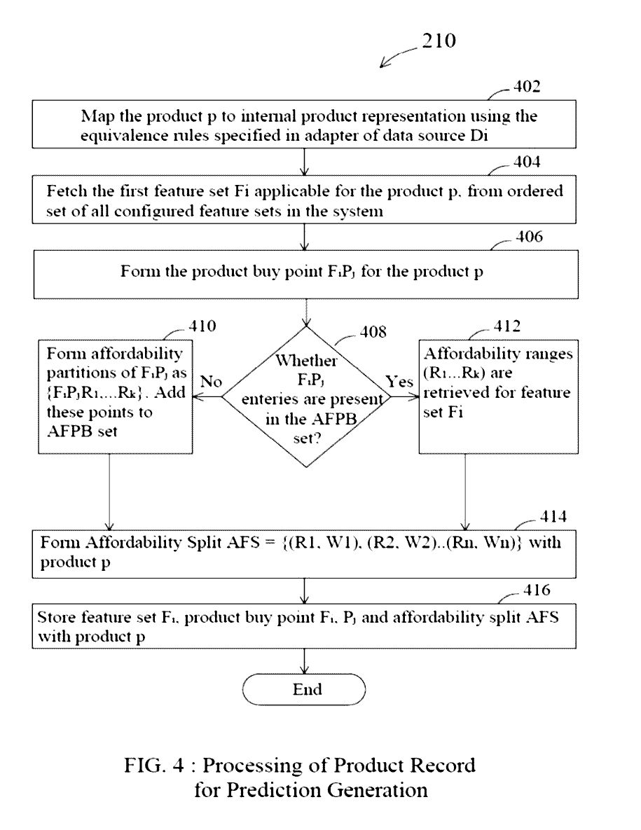

Referring now to FIG. 2, a method of prediction generation in a Unified Predictive Retail Eco-System is illustrated in accordance with an embodiment of the present subject matter. At step 202, for each data source Di, a corresponding weight Wi is fetched. The weights are determined as described in FIG. 1. At step 204, a customer record is fetched. The customer record is indicative of a customer profile along with sale/purchase/browsing history associated with each customer. At step 206, for each customer record, the processing is executed as described in detail in the flowchart shown in FIG. 3. Similarly, at step 208, product records are fetched. For product records, the product records are processed in step 210 as described in detail in a flowchart shown in FIG. 4.

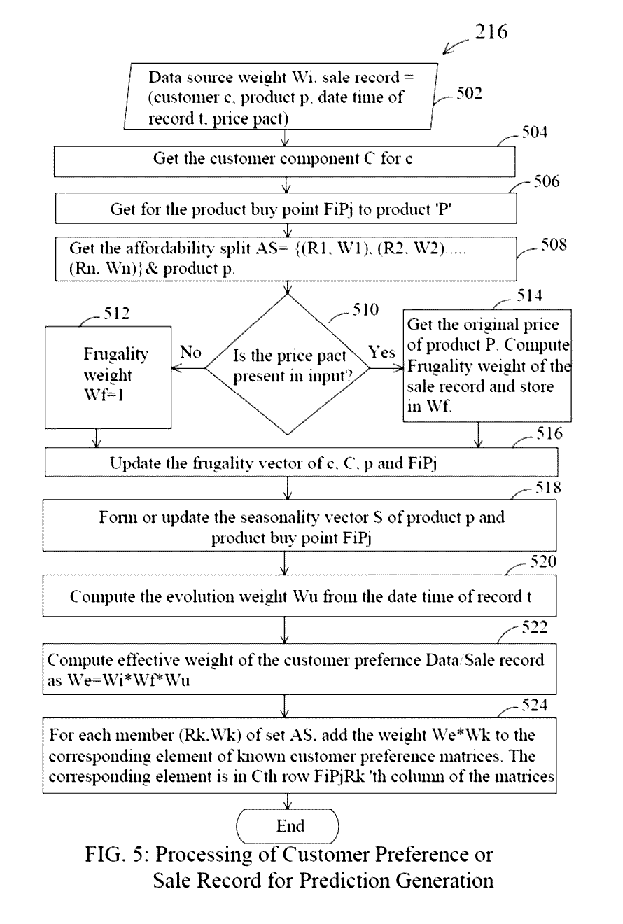

At step 212, an empty data matrix having a Customer to Product (C×P) structure is created, wherein in one example, the rows may contain customer data, and the columns may contain product data. In one example, the product data can be affordability partitioned, wherein the affordability partition is indicative of a price range of a corresponding product. In one example, the affordability partition may be a price range whereas in another example the affordability partition may be an exact monetary value indicative of the price of the product. Further, as shown in step 214, the customer record is fetched for each sale record. Further, at step 216, the customer record is processed as described in detail in the flowchart shown in FIG. 5. Further, at step 218, the Singular Vector Decomposition method can be utilized to compute non zero values in a customer preference matrix, wherein the non-zero values are indicative of a predicted product. At step 220, the predicted customer preference matrix with only predicted values as non-zero elements and all other elements as zeros is stored.

Referring now to FIG. 3, a flowchart 206 illustrating the processing of a customer record for prediction generation is shown in accordance with an embodiment of the present subject matter. As shown in FIG. 3, after the customer record C is obtained from the data source 102, the customer record is fed as an input from a data source Di to step 302. In step 302, the customer C is mapped to an internal customer representation Ci using equivalence rules specified in an adapter of the data source Di. In step 304, the customer C with all attributes present in the data source is stored as internal equivalent customer Ci. In step 306, the customer Ci is formed or generated from the customer C based on the attributes of the customers specified in the configuration. In step 308, it is checked if Ci is present in the internal customer component set CC. If not, the customer Ci is added to the internal customer component set CC. In step 310, the customer C is associated with the internal customer Ci and stored with specific customer Ci. In step 312, all customer component sets CC={C1, C2, . . . Cp} are stored, where C1 to Cp are distinct customer components or segments. In one implementation, elements of this set form the customer dimension of the C×P matrix.

Referring now to FIG. 4, a flowchart 210 for processing of product record for prediction generation is shown in accordance with an embodiment of the present subject matter. As shown in the FIG. 4, a product record p of a data source Di 102 is used as an input for step 402, where the product p is mapped to an internal product representation using equivalence rules specified in an adapter of the data source Di 102. In step 404, a feature set Fi applicable for the product p is fetched from an ordered set of all configured feature sets in the system. At 406, a product buy point FiPj for the product p is formed. For example, a product buy point is the specific value of each of the plurality of the decision making feature set values for a specific product. There exists only one such product buy point to which a specific product belongs. There can be multiple products belonging to each such product buy point set of feature specific feature values, in history, the present, as well as the future. In step 408, it is checked whether FiPj entries are present in the AFPB Set. If no, then at 410, affordability partitions of FiPj as {FiPjR1, . . . Rk} are formed and added to the AFPB set. If yes, then at 412, affordability ranges {R1, . . . Rk} are retrieved for feature set Fi. In step 414, an affordability split AFS={(R1,W1), (R2,W2) . . . (Rn,Wn)} is formed with product p. Finally, in step 416, the feature set Fi, product buy point FiPj, and affordability split AFS is stored with product p.

Referring now to FIG. 5, a flowchart 216 illustrates processing of customer preference or sale record for prediction generation in accordance with an embodiment of the present subject matter. After the first part of processing customer and product data (as explained in FIG. 3 and FIG. 4), the structure of the C×P matrix is ready for use for further processing. In one embodiment, for each of the data sources Di 102, a correspond me C×P matrix is the known customer preference matrix. The summation of all such matrices is the universal customer preference matrix. Once the universal customer preference matrix is populated, SVD techniques are applied to predict the non-zero values. The C×P Matrix containing only the predicted values as non-zero entries is the predicted customer preference matrix.

As shown in FIG. 5, in step 502, for each of the customer preference records or sale records of data sources Di 102, the input is a data source weight Wi. The sale record=(customer c, product p, date time of record t, price Pact). Note that the price of the product in the customer preference data may be absent. In step 504, the Customer Component C for a customer c is fetched. In step 506, the product buy point FiPj is fetched for the product P. At step 508, the affordability split AS={(R1,W1), (R2,W2) . . . (Rn,Wn)} of the product p is fetched. At step 510, it is checked if the price Pact is present. The price Pact is indicative of the actual sale price of the product. If no, then at 512, Frugality weight Wf=1 . If yes, then at 514, the original price of the product p is fetched and a frugality weight of the sale record is computed and stored in Wf.

At step 516, the frugality vector of c, C, p and FiPj is updated. In step 518, the seasonality vector S of product p and Product buy point FiPj is either formed or updated. In step 520, an Evolution weight Wu from the date time of record t is computed. In step 522, an effective weight of the customer preference is computed as We=Wi*Wf*Wu. In step 524, for each member (Rk,Wk) of set AS, the weight We*Wk is added to the corresponding element of Known Customer Preference matrices. The corresponding element is in Cth row and FiPjRk'th column of the matrices.

It is to be understood that retail business can have multiple product types. First entity is the decision making attribute set which is not an isolated individual attribute set of a product, but a combination of all aspects which help in decision making for buying the product. In one example, for a clothing business, while shirts of white colour may be preferred by a person, but trousers of white colour is probably the least liked choice. In oilier words, different products sold by the retailer can have different decision making feature sets.

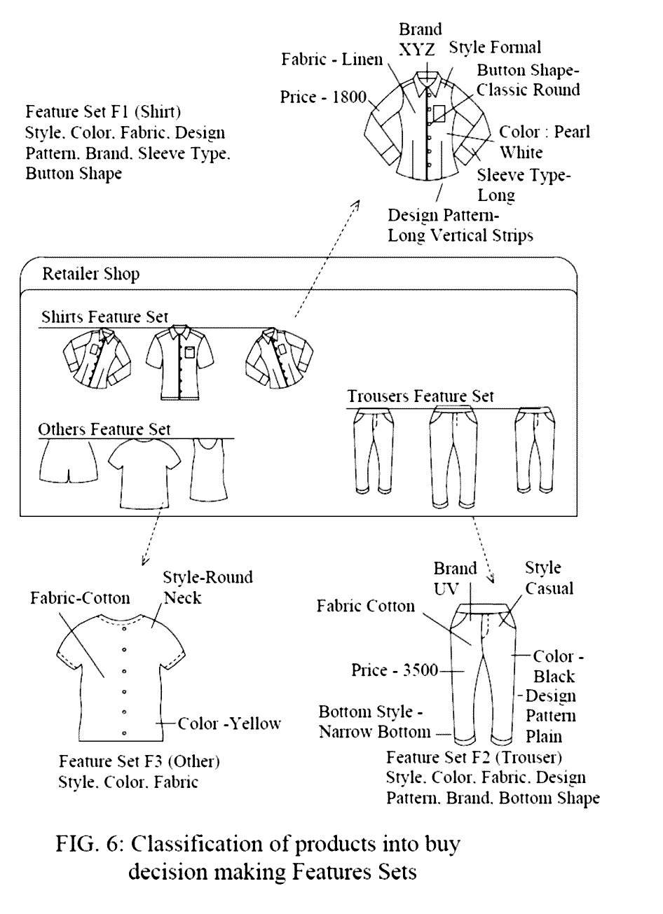

Referring now to FIG. 6 which illustrates classification of products into buy decision making feature sets in accordance with an embodiment of the present subject matter. Out of all the possible combinations of all the values of a specific feature set's individual features, a specific retail business is characterised by a specific combination of values. A buy decision is made, more on a specific combination of attribute values, than values of a single attribute alone. A person who likes white color polyester shirt with long sleeves may actually like red color cotton shirt with short sleeves and not the corresponding white variety. Approaches constructing customer profile with color=white by using the preference information of long sleeves shirt will have limited use in predicting red color shirt buy. Or using both of them to suggest new ones.

The products sold in a retail business constitute actual buy points. They are much smaller in numbers compared to the all the combination of values possible for each of the individual features. All these product buy points constitute the most fundamental characterization of the retail business. Recording of these buy points from all historical data sources eliminates the need of using algorithmic construction of clusters. Every item present in the customer preference data belongs to one such buy point set. Almost all new items encountered also belong to one such point. Most important the specific combination of values of all attributes of a feature set becomes the fundamental decision point and not values of individual feature values in isolation.

FIG. 6 depicts the process of identifying all the buy decision making feature sets of a particular retailer. All products are classified in such a manner that one product belongs to one and only one feature set. Each feature set has one or many distinct features. Each product belonging to a particular feature set has values of all the individual features of the feature set.

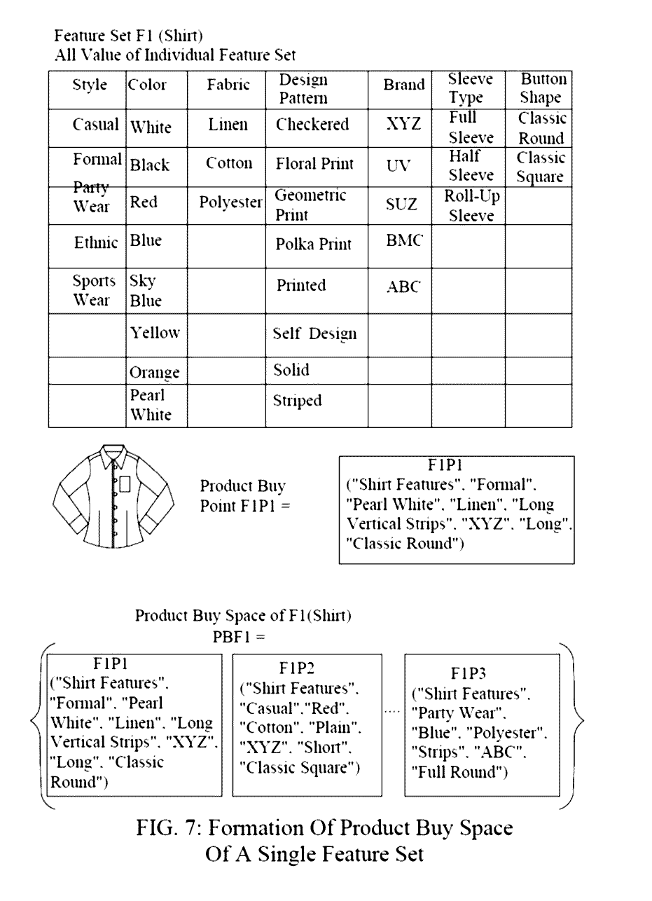

Referring now to FIG. 7 which illustrates the formation of a product buy space of a single feature set in accordance with an embodiment of the present subject matter. The formation of the product buy space of a single feature set shows how a products buy space is formed by taking an example of a “shirt” feature set of a clothing retailer. In one implementation, every feature's product buy space set contains all the product buy points of products of the retailer belonging to that feature set. A product buy point is a set of specific combination of individual feature values that has occurred in at least one actual product. N number of distinct products are associated to one product buy point, where min(N)=1. The product buy point FiPj={Name of the feature Sets Fi, Actual Value set Pj of all features of Fi} is computed and stored for each of the specific products. The Universal Product Buy Space is formed by considering products from all the historical data sources. The equivalence between the two products from different data sources is obtained by the foreign key mechanism across the two product sources. From the table shown in FIG. 7, the total number of potential combinations is 6*8*3*8*5*3*2=34560. For a retailer, only a small subset of all possible combination of feature values characterize products of any specific feature set.

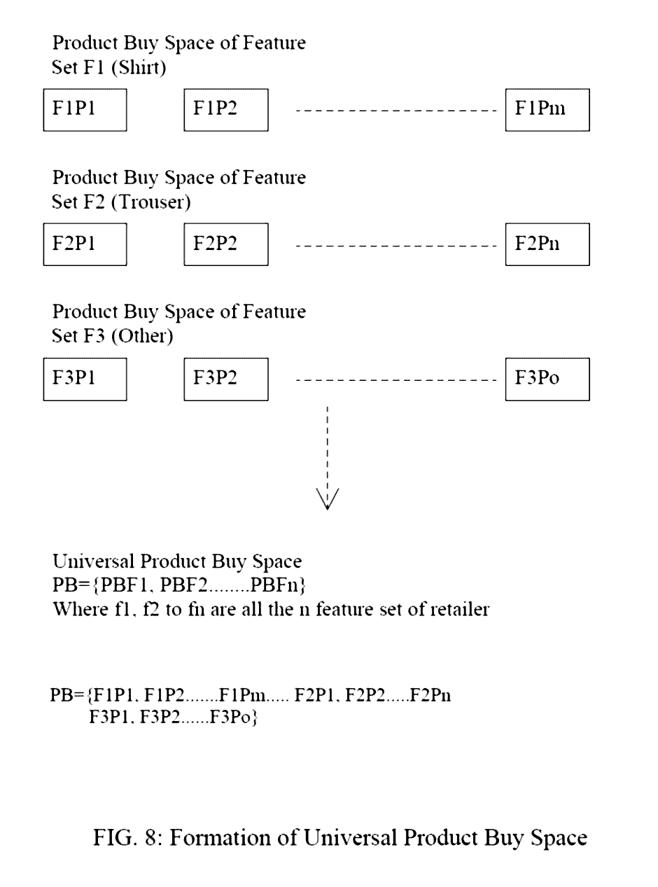

Referring now to FIG. 8 which illustrates the formation of a universal product buy space in accordance with an embodiment of the present subject matter. As shown in the figure, a plurality of individual buy spaces having corresponding feature sets are compiled together to form a universal product buy space. In one example, the total universal product buy space of a retail business is formed as set of product buy space of all the feature sets.

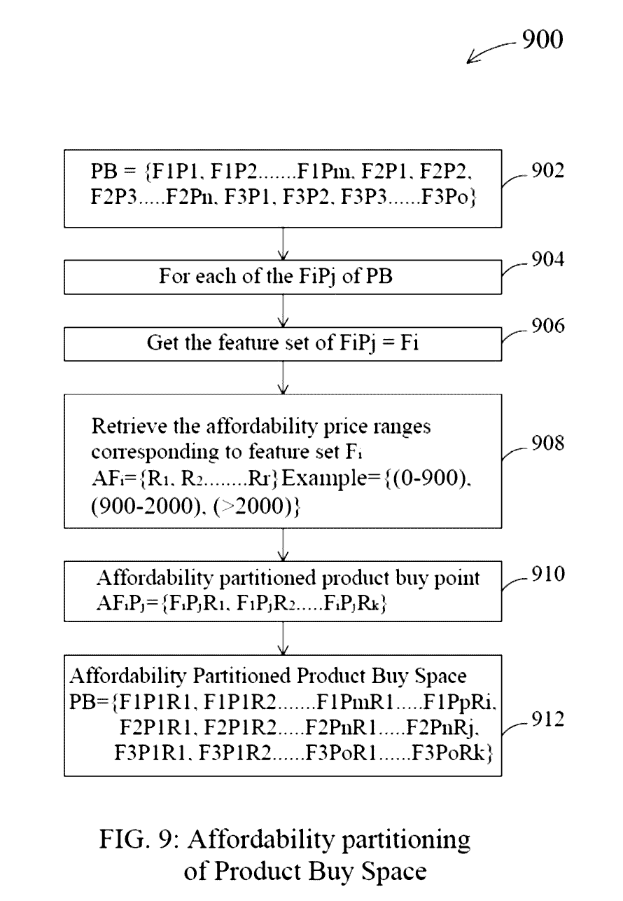

Referring now to FIG. 9 which illustrates affordability partitioning of a product buy space in accordance with an embodiment of the present subject matter. According to an implementation of the present subject matter, the second retail entity used in predictive analytics herein is the affordability of a product towards buying that specific product. Even though a customer likes a product with a specific set of feature values or Product Buy point as described earlier, their actual buy decision can be substantially influenced by the price of the product. Generally, the price of an item is far more important than any other attribute in modelling a retail business for the purpose of Predictive Analytics. According to an implementation of the present subject matter, affordability is not simply a customers' ability to purchase, but is the ability or willingness to buy a particular product type of a feature set, at certain range of price. This is referred to as the affordability of the product type for that feature set. For example, in a jewellery domain one customer who buys a diamond ring may buy only the most expensive solitaire rings, but the same customer when buying a wrist watch maybe buying only the low cost electronic quartz watches.

Every product has a selling price P. It has associated product buy point FiPj={Name of the feature Sets Fi, Actual Value set Pj of all features of Fi}. For example of “Shirts” affordability ranges set can be Afi={(0,900), (900,2000), (>2000)} if a particular shirt is priced at 1000 Indian Rupees (INR) and a customer's preference into the product by buying it is recorded in sales data. Then it means that customer wants to buy the FiPj product buy points. It also means that he wants to buy product at or around INR 1000. It also means he is interested in buying product of that feature set in 0 to 900 and >2000 range to a lesser degree than 900 to 2000 range. The next set of ranges with distance 2 from the 1000 range should have a lesser effect and more the distance the less should be the weight of one sale at 1000 in that range. The effect of the sale of this product cannot be only in the range of 900 to 2000.

For each feature set Fi, an affordability range AFi={R1,R2, . . . , Rn} is defined. Depending on the price P, the product may belong to one of the price ranges Ri. The affordability split of product={(R1,W1), (R2,W2) . . . (Rn,Wn)} where Wi is the weight of one single product sale into the i'th affordability range of AFi. 0<=Wi<=1. A variety of algorithm's to come up with these weights Wi's are possible which includes components of a distance of price from the centre of the range and dampening factor while computing weights in the following and preceding ranges. The output weights Wi's are such that ΣWi**2=1. For every product P Along with product buy point FiPj, the corresponding affordability split {(R1,W1), (R2,W2) . . . (Rn,Wn)} is also stored.

One sale of product with buy point FiPj contributes to each of the FiPjRk affordability partitioned product buy points of the customer's row in the C×P Matrix. Where the value contributed to the element is the weight Wk corresponding to Rk range weight of the affordability split of the product.

According to an implementation of the present subject matter, a product buy point representing a specific set of values for each of the attributes of the feature set is split into N affordability partitioned product buy points, wherein N is the number of price ranges for the feature set F of the product. FIG. 9 illustrates this “Affordability Partitioning of Product Buy Space”. The set of all the distinct affordability partitioned product buy points collectively form the Affordability Partitioned Product buy space of the retailer. This set forms the Product dimension of the Customer×Product matrix.

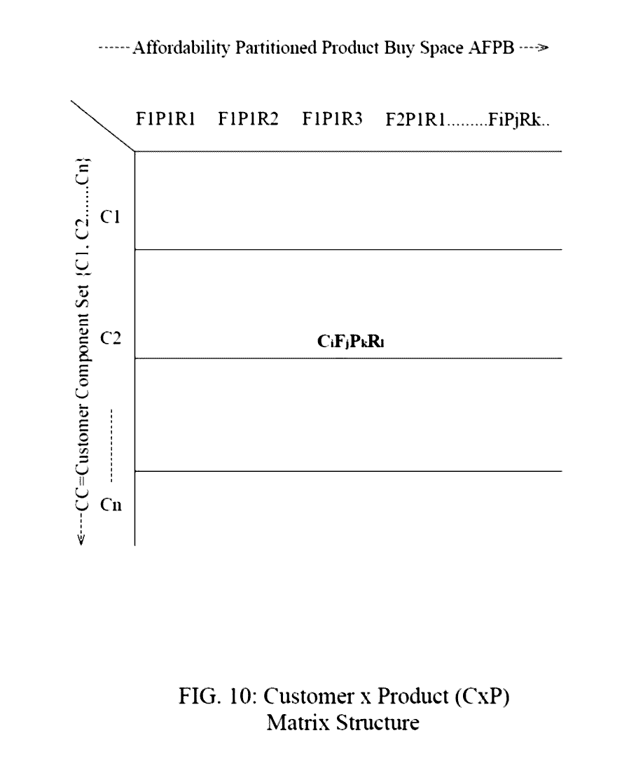

FIG. 10 illustrates a customer×Product (C×P) matrix data structure in accordance with an embodiment of the present subject matter. This is the key data structure which is formed from abstractions of retail entities disclosed in the present subject matter. In one implementation, in the shown matrix structure, rows are labelled by the customer components, and columns are labelled by the affordability partitioned product buy points. For each of the data source Di corresponding C×P matrix is called the Known Customer Preference Matrix. The summation of all such matrices is Universal Customer Preference Matrix. An element CiFjPkRi represents the Ci's unified preference for affordability partitioned buy point FⱼPₖRᵢ. Where Fj is the jth feature set, Pk is one combination of specific values of each of the features of the feature set Fj, and R1 is the I'th price range of Affordability defined for the feature set Fj.

The third retail entity abstraction or parameter is frugality, which can be said to be reflective of the tendency to be economical. Some customers' have a tendency to be more sensitive to the amount of discount in making the buy decision compared to others. This tendency is not only restricted to the customer dimension but can be generalized to include the product dimension also i.e. some products have the higher likelihood of being bought with deep discounts while others are not so sensitive to discounting. In an extreme case when product is being sold at 100% discount, all the customers will like to buy all the products.

In one example, the more the discounting present in a particular sales record the lesser should be importance of the record in generation of the predictions. The Frugality ranges F={(L1,D1,D2,W1), (L2,D2,D3,W2) . . . } where D1<D2 and D1 and D2 are discount levels in % and W1,W2 etc are the fractional weights or importance of the sale with that level of discounting. L1,L2 . . . are the labels given to the frugality range for the ease of use for campaigning or other applications. If the discount for any sales record is D and D1<=D<D2, then the corresponding weight W1 is the frugality weight of the sale record.

For example, F={(None, 1, 0.8, 1), (Low, 0.8, 0.6, 0.7), (Medium, 0.6, 0.4, 0.4), (High, 0.4, 0.0, 0.1)} can be the frugality ranges defined. It means for a product sold at 50% discount the corresponding weight will be 40%, while for all products sold over 60% discount the sale record should have no effect.

In an embodiment of the present subject matter, the first implication of frugality in predictive analytics is at the time of formation of C×P matrix elements. Every sale for customer Ci contributes as the customer's preference in the product to all corresponding columns of affordability partitioned product buy points of the Customer's row Ci. This weight for every sale record is obtained from the Frugality ranges stored and is multiplied to the weights of sale record before adding it to the corresponding elements. The method of calculating frugality weight of a sale entry works as for each sale entry cp of customer c of product p is to first get the sale price for the product as Psale, then retrieve the actual price of the product Porg, calculate the discount Pdis=100*(Porg−Psale)/Porg), and get the frugality weight for the range to which Pdis from frugality configuration belongs.

A frugality vector showing the sensitivity to tendency to be frugal is stored for each of the product and customer. At the time of processing of sale records frugality range is obtained and the frequency of corresponding component of the frugality vector incremented, the vector is stored for the corresponding customer as well as product. At end of processing of all of the 20 sale records the resulting frugality vector of the customer or product may look like Fc1={None=7, Low=8, Medium=5, High=0}. In this example Frugality fraction of the customer c1 for Low discounting, is Low=8/20 (frequency/total number of sales) or in general this customer is not much influenced by the discounting. These frugality fractions can be used for various business related purposes. Including designing of campaigns. A clearance sale campaign may be more interested in customers with High frugality, while a campaign which introduces premium product may target none or low frugality customers.

In one example, the frugality vector can be stored for each of the specific customer as well as the corresponding customer component as the normalized value of all the customers belonging to that customer component. Similarly for each of the specific products or the corresponding product buy point. The fourth retail entity or parameter is the seasonality of the product. Seasons are configured as specific date range in any particular time unit of a year, month or even day. For the year unit S={(S1,D1,D2), (S2,D2,D3) . . . (Si,Ds,De) . . . } Where Si is the name of season, Ds is the starting date of the season and De is the ending date of the season. And No two season date range overlap each other. Any number of seasons in a time unit can be defined with start and end values applicable to that unit.

For a product at the time of processing of sale record, the value of the season is obtained for the date of sale and corresponding frequency count of the season in the product vector is incremented by 1. For a product p which was sold 20 times seasonality vector may look like Sp1={S1=7, S2=8, S3=5, S4=0}. In this example Seasonality of the product for Season S2 is S2=8/20. The seasonality of the products can be used for various purposes including designing of campaigns which include only predicted products applicable in that season.

According to an implementation of the present subject matter, the fifth retail entity or parameter is evolution, which is indicative of the changing behaviour of the customer over a period of time. The customer preference for products changes over time or the customer's preference for product evolves over the period of time. For example the preference shown in the product in shirts ten years ago by a customer of current age 20 probably has undergone a complete change by now. Different business' have different Sensitivity to customer evolution. Evolution is configured as E=(TimeDuration, reduction). Where importance of sale records decrease by reduction % every Time interval TimeDuration. For example if TimeDuration=1 year and reduction=20% one year older sales record will have a weight of 0.8, two year sale record will have a weight of 0.6 and 5 years and older records will have no impact in the formation of C×P Matrix elements and prediction generation process.

The evolution fraction is computed for every sale record as per the configuration. This factor is multiplied before adding the weight to the corresponding CiPj entries of the C×P matrix. The method according to the present subject matter creates predictions based on the methodologies of abstractions of the five retail entities or parameters as described above.

In an implementation of the present subject matter, the outputs of the Prediction Generation Process are:

1. The Known Customer Preference Matrices: The customer preference data is populated in terms of Customer Components and Affordability Partitioned Product Buy Points in C×P matrix. For each of the data sources this C×P normalized matrix is stored. A Universal customer preference matrix as a sum of all data source Matrices having cumulative product interest of customer from all sources is also stored. For example there can be one matrix each for physical historical sales data, online orders and browsing history. Each of the matrix contains rows which are normalized, various normalization techniques including Euclidean norm can be used whereas summation of square of each element of that row is 1.

2. The Predicted Customer Preference Matrix: This is a single C×P matrix with only predicted values obtained from normalized weighted cumulative customer preference matrix. One of the important goal's of the invention is to compute unified customer interest from all data sources into the products.

3. The seasonality vector of a product buy point for each of the product buy point PB={Feature Set Name=f, specific feature values of set f} a seasonality vectorS is={S1,S2, . . . Sn} where S1 to Sn are n seasons defined in a year. & ΣSi**2=1.

4. Frugality Vector of Customer and Customer Component: For each of the ci individual customers as well as Ci a customer component. Frugality vector has frequencies for all frugality ranges defined, so that a frugality fraction between 0 and 1 can be computed for any frugality range as frequency/total sales such that closer the value to 1 the more the Customer Ci is frugal or affected by the discounting of products.

5. Frugality Fraction of an individual product p or Product Buy Point: For each of the product p or PB a Product Buy Point, using Frugality vector frugality fractions for all frugality ranges can be computed, between 0 and 1 such that close the value to 1 the more the products represented by Product Buy PB is frugal or affected by the discounting in price.

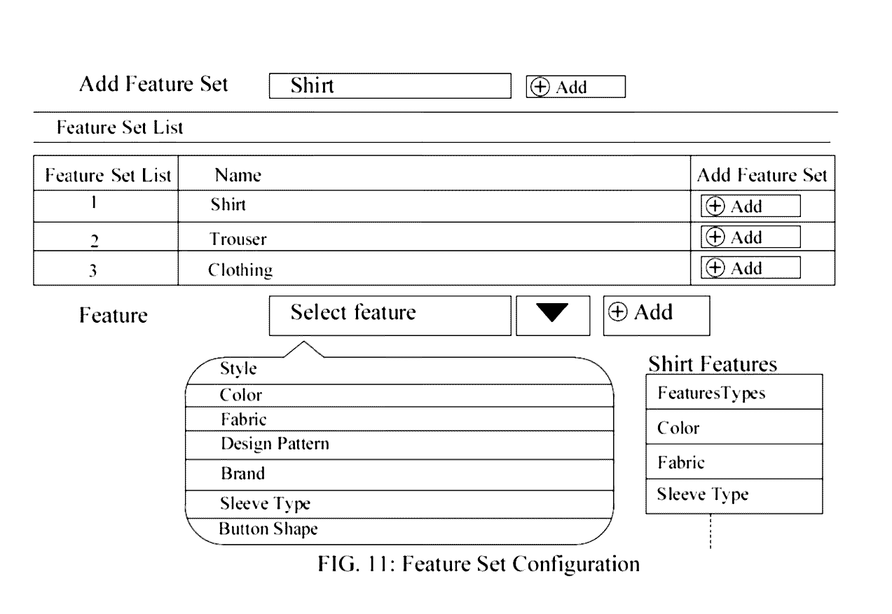

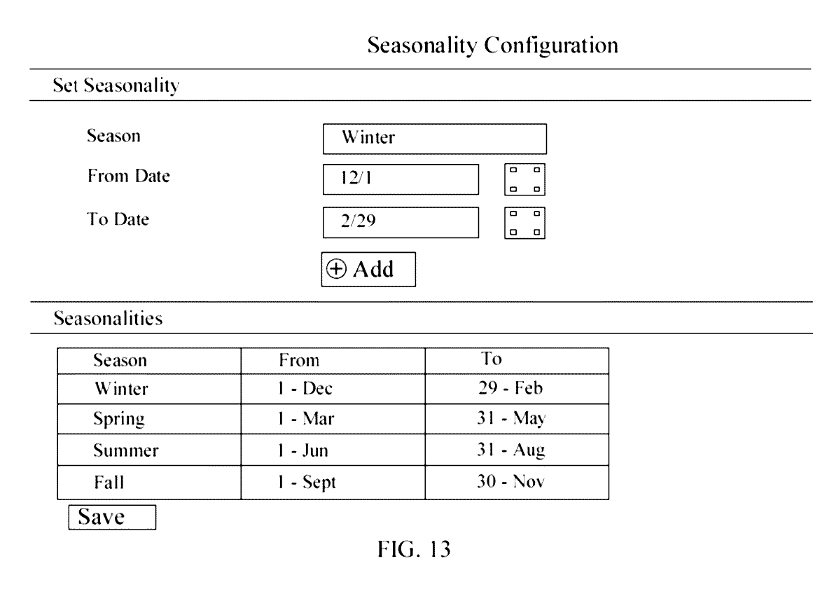

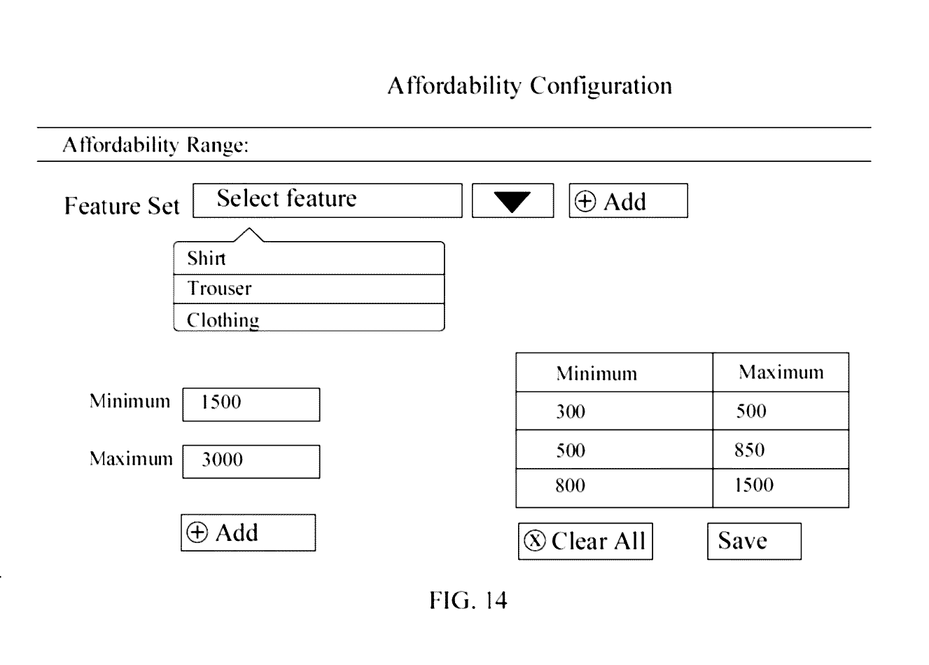

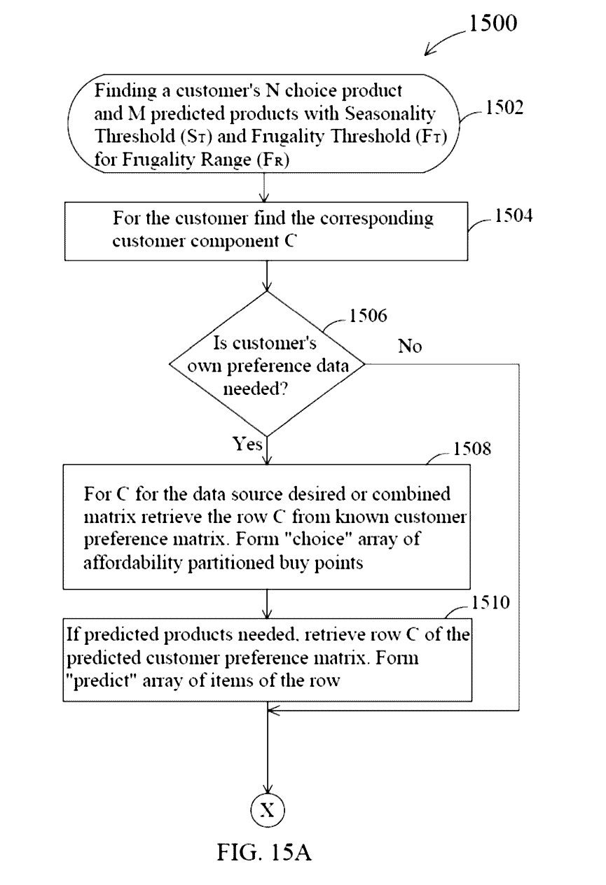

FIGS. 11 to 14 illustrate a configuration interface for adapters, feature sets, affordability, seasonality, frugality and Evolution parameters in accordance with an embodiment of the present subject matter. In one example, the UI can be configured as a Graphical User Interface to operate on any given operating system known in the art, such as Windows, Mac OS, Android, or iOS.

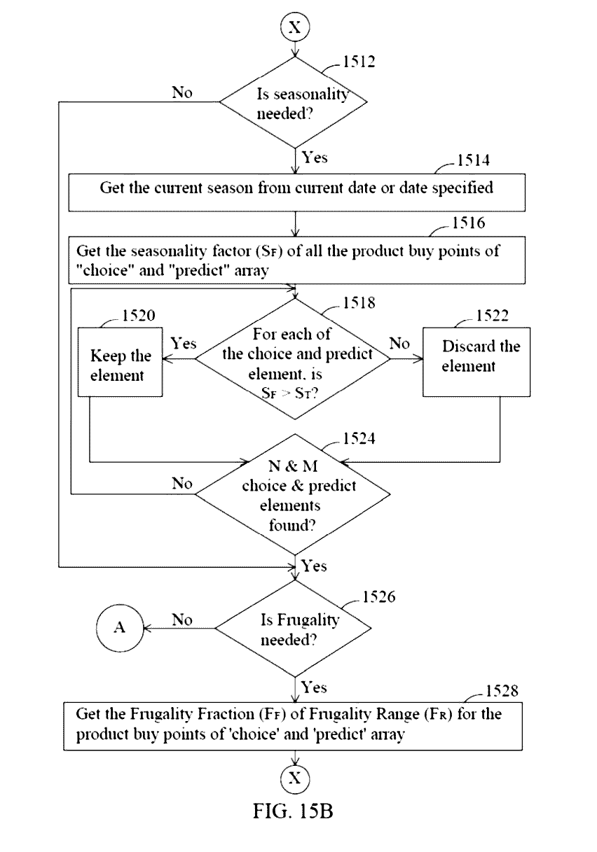

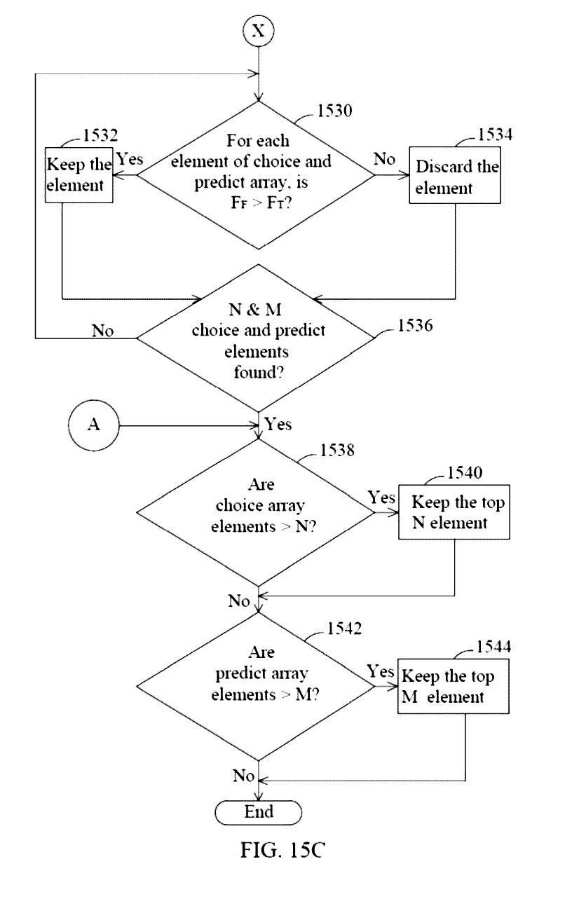

For a specific customer his choice of products and predictions for him can be obtained by using the outputs generated by the prediction generation algorithms. This is shown in FIG. 15.

FIGS. 15A, B, and C illustrate a method of finding a customer's N choice products and M predicted products with seasonality and frugality in accordance with an embodiment of present subject matter. At step 1502, a customer's N choice product and M predicted products are determined. The N choice product and M predicted products are associated with seasonality N threshold (St) and Frugality threshold (Ft) for frugality range (Fr). At step 1504, for a customer from the customer profile, a corresponding customer component C is found. In step 1506, it is checked whether a customer's own preference data is needed or not. If yes, in step 1508, for the customer component C, the corresponding row from the customer preference matrix is retrieved. Subsequently, the desired affordability partitioned buy points are formed. In step 1510, if the predicted products needed, retrieve row C of the predicted customer preference matrix. Form a predict array of items of the row. If not, the steps 1508 and 1510 are skipped and the control is transferred to step 512 directly.

At step 1512, it is checked whether seasonality is needed, if the seasonality is needed, then at step 1514, the current season can be fetched either from the date or time stamp, or front a specified date or time stamp and at step 1516, the corresponding seasonality vector/factor (Si), for all the product buy points of “choice” and “predict” array, is retrieved. Then at step 1518, for each of the choice and predict element, it is checked whether Seasonality factor (Sf) is greater than Seasonality threshold (St). If Sf>St, then that element stored at step 1520. Alternatively, the element is discarded at step 1523.

Further, at step 1524, it is checked whether N & M choice and predict elements are found. If no, the control transfers to step 1518. If yes, it is checked whether frugality is needed, at step 1526, If frugality is not needed, then the process flow goes to step 1538. However, if frugality is needed, then frugality fraction (Fr) of Frugality Range (Fr), for the product buy points of choice and predict array, are fetched.

Subsequently, at step 1530, for each element of choice and predict array, it is checked whether F_{f}>Fₜ If yes, then that element is stored at 1532. If not, then that element is discarded at 1534. Further, at step 1526, it is checked whether N & M choice and predict elements are found. If no, the control transfers to step 1530, if yes, then at 1538, it is checked whether the choice array elements are greater than N? If yes, then at 1540, the top N elements are stored and the process flow goes to 1542. If not, then at 1542, it is checked whether the predict array elements are greater than M? If yes, then at 1544, the top M elements are stored. If not, the process ends.

To sum up FIG. 15, it is to be understood that for each of the products, the seasonality consideration is applied and selected if the product qualifies in the threshold. This is continued till the products in the selected rows are exhausted. In the event that the seasonality consideration is not required, the method can be skipped directly to check whether the frugality consideration is required. The frugality threshold is applied and all products falling within the desired frugality range are selected in the respective array, and otherwise discarded from the selection for prediction in accordance with the present subject matter. Further, for each of the element product buy points, in the ‘choice’ and ‘predict’ arrays, all the products are fetched based on the desired parameters so that the total number of products are N and M. In the end, the seasonality and frugality considerations/vectors are applied to the ‘choice’ and ‘predict’ array products.

For example, five of the products that a customer has browsed on an ecommerce site. This is done by sending the data source=“Browsing History”, Choice=“5”, Predict=“0” and if needed Seasonality=“True” and Frugality in None and Low can be specified.

Note that as part of the algorithm, the two output array structures returned namely, the “Choice” array and “Predict” array are first obtained in terms of affordability partitioned product buy points FiPjRk. The output can be returned in terms of these points or the current inventory actual products matching these points, as per the need of the application.

A combination of Choice and Predict product can be obtained for any specific or all the combined data sources. If multiple product's in the current inventory match the affordability partitioned product buy points the products selected can be on the basis of policy like oldest first, lowest inventory first, highest inventory first etc.

### Some Applications of the Present Subject Matter Are

### The Predictive Seasonal Campaigning System

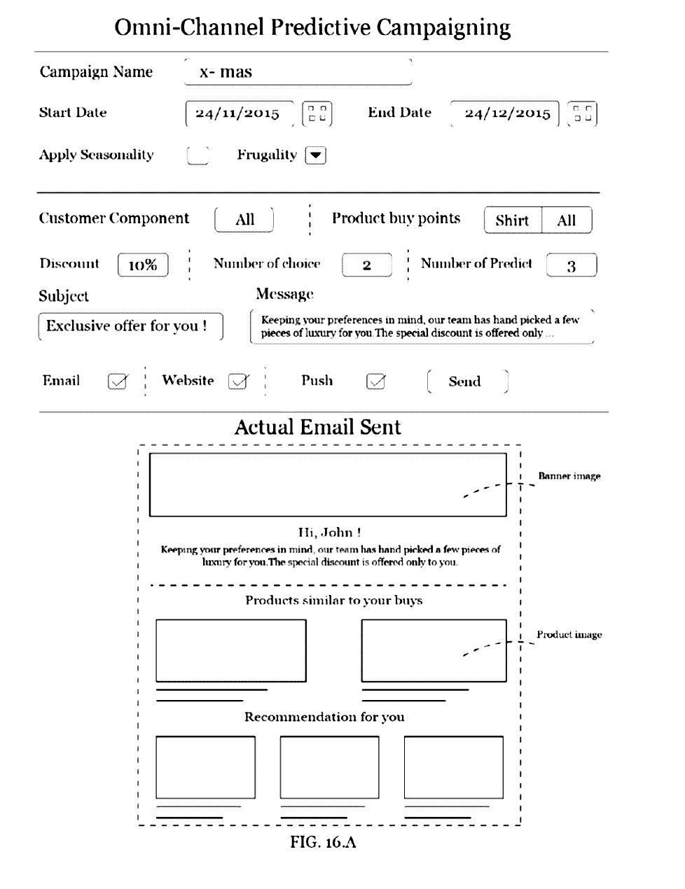

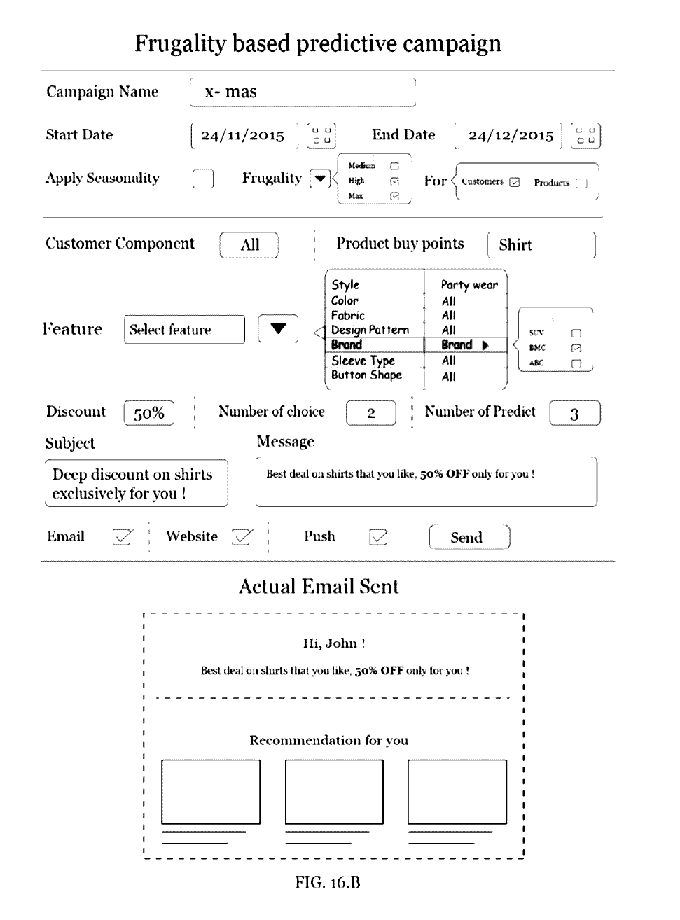

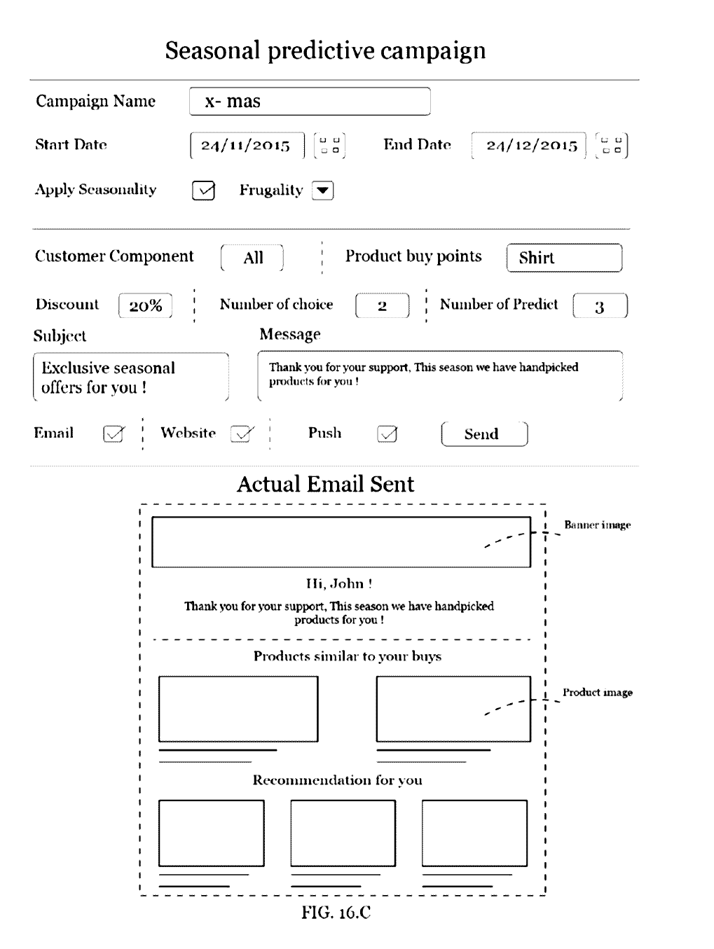

FIGS. 16a, b, c, show an Omni Channel Predictive campaigning application which can send individual predictions obtained as output to selected customers from selected products belonging to specific buy points. The application can send same campaign as emails, personal contents on store front or as push notifications to customer's mobile application. Example of the OmniChannel Predictive campaigning system in the retail eco-system which utilizes all the outputs of Prediction Generation Process, is shown in FIGS. 16a, b and c. First example depicted in FIG. 16a shows a campaign intended for promotion of all shirts. For this campaign shirts is chosen as the feature set. For customer component all customers are chosen. Total number of 2 choice products and 3 predict products are desired to be sent as individual offers for each customers. Campaign validity period is from 24 Nov. to 24 Dec. 2015. Campaigning system invokes algorithm of FIG. 15 A for each of the customers with the Choice=2 and Predict=3. With additional constraint (not shown in the FIG. 15 a) of the predictions which have product buy point associated with Shirt feature sets are to be retrieved. The retrieved prediction in terms of product buy point are translated into actual product in the inventory. When multiple products in inventory are available a policy can be applied to select the products. For all customers of the customer component these 2 choice and 3 predict product becomes the custom offers. For a customer ci there can be 5 offers 2 of choice and 3 of predict. A specific dynamic coupon or set of coupons are generated by the campaigning system for customer ci which gives discount of 10% valid for the campaign validity period, for the customer's specific products. These coupons can be auto exported to the ecommerce server system. The generated offers with the specified subject and message can be sent as email, on store personalization content or as mobile push notifications to all the customers.

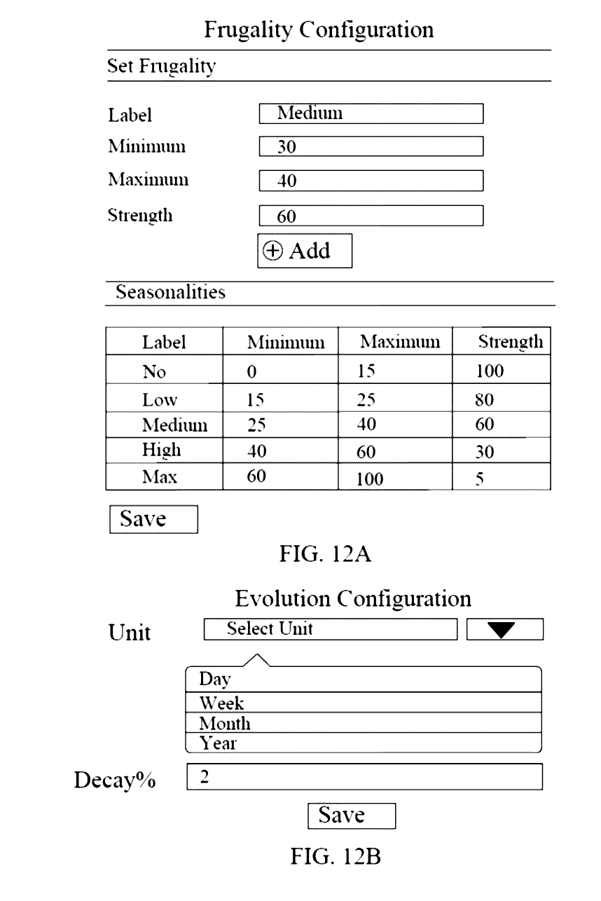

FIG. 16 b is an illustration of Frugality based campaign, where selected products with deep discounts are sent to the customer's having high frugality fraction of high or max frugality range. In other words, FIG. 16 b is an example of campaign in which the objective is to sell a particular set of products. This covers the “clearance sale” type of campaigns where certain pieces in inventory are targeted to be sold. Similar situation is applicable in many other scenarios including selling of a selected item lots which are obtained at deep discounts. Specific product is chosen along with the desired choice and predict numbers. For the product chosen the corresponding product buy point is obtained by the campaigning system. The offers are generated similar to the process described in the 16 a. The only change in this scenario is the specification of “High” or “Max” as the frugality range for the customers to select. With the case of frugality ranges defined as in FIG. 12. A High and Max frugality will mean the corresponding fractions of customers having highest weight in these two discounting range buys compared to all the other ranges defined. Highly frugal customers tend to buy much more during deep discounting compared to others.

FIG. 16C shows seasonal campaigning which uses seasonality factor/vector for the season of campaign and send special individual offers based upon a season. Specifically, FIG. 16 c adds on top of the scenario of 16a with the additional constraints of the “seasonal” campaign. In such a scenario only the products which have configured high seasonal correlation with the season of the validity of the campaign are retrieved as individual offers.

### Every Customer's Own Store

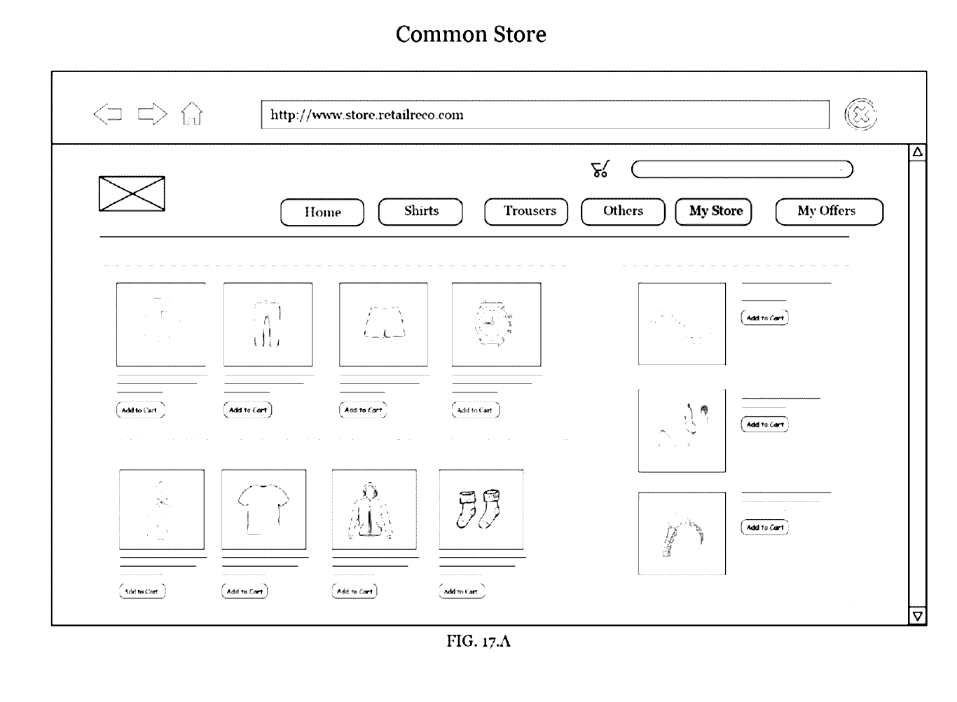

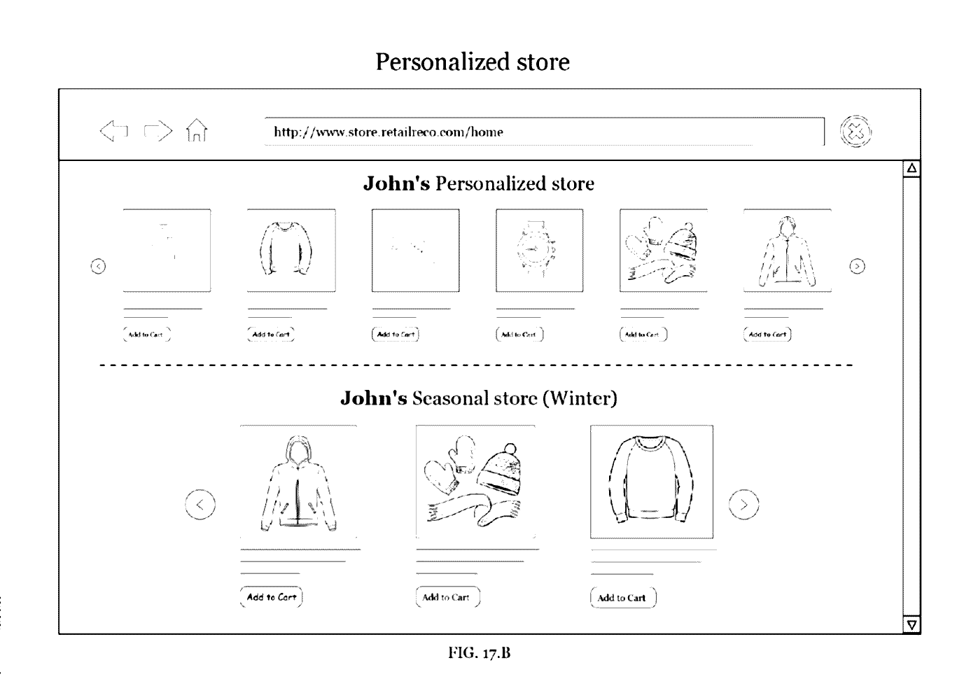

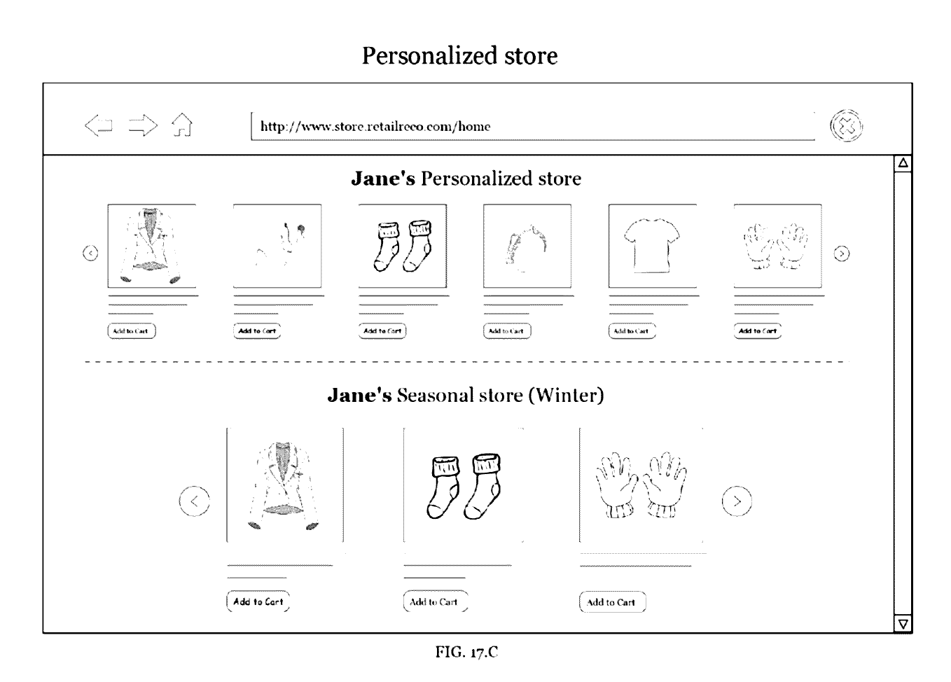

Example of an ecommerce site which utilizes the output of Prediction Generation Process is shown in FIG. 17. In this system the store any specific customer sees is based on a configurable user interfaces blocks of his own customer preference data. The customer preference data shown can be from any of the existing customer data preference sources or from the choice or predict arrays generated product(s) retrieved for him. The same customer's own store also can keep on changing according to changing catalog and inventory as the product buy points can remain constant. But the mapped product into current inventory can keep on changing. If Seasonality is desired only the products of choice and predictions which match the seasonality criteria will be visible to the customer in his own store.

### Location Based Predictive Custom Mobile Store

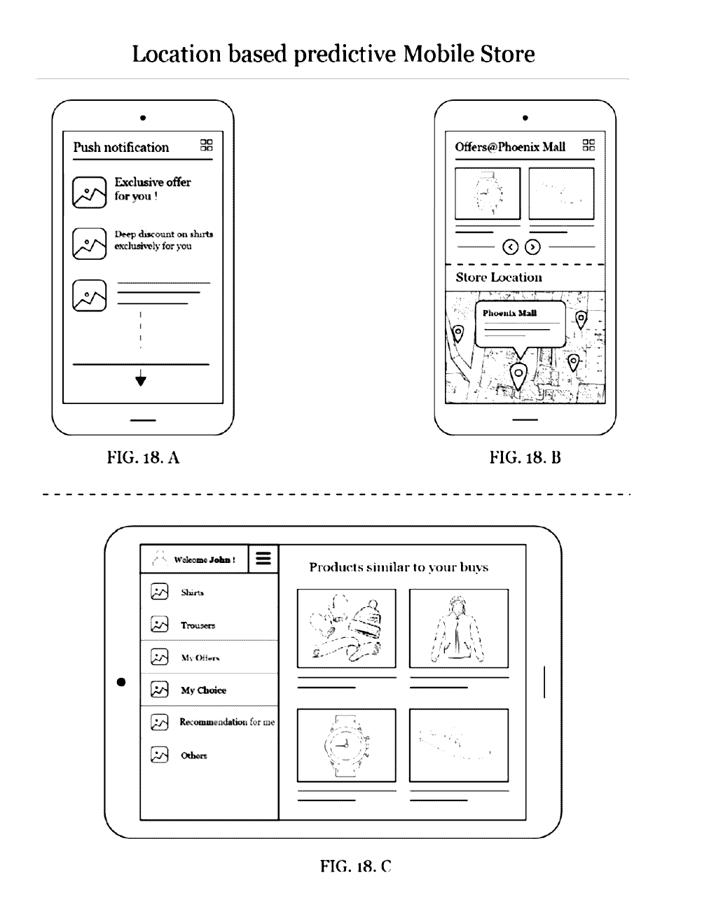

FIG. 18A shows a mobile app of John (a customer). The mobile application may enable offers to be received as push notifications when customer is in the vicinity of a particular store. Offers specific to the customer are also available as “Special Offers.” Customer's choice and predict (recommendations) in addition to the standard store view is also available. Offers of OmniChannel Predictive Campaigning application are received as push notifications by John (any particular customer).

FIG. 18B shows location aware predictive offers received as push notifications by John's when he is in the vicinity of a particular store in “Phoenix Mall”. Out of all the offers on thousands of products at a particular store only predefined numbers of offer which are choice or predict of John are received as special offer to him.

FIG. 18C shows the mobile store of John which features his “Special Offers” generated in the campaigns. His choice and predict (recommendations) in addition to the standard store view.

### Feature(s) Sensitivity Analysis Application

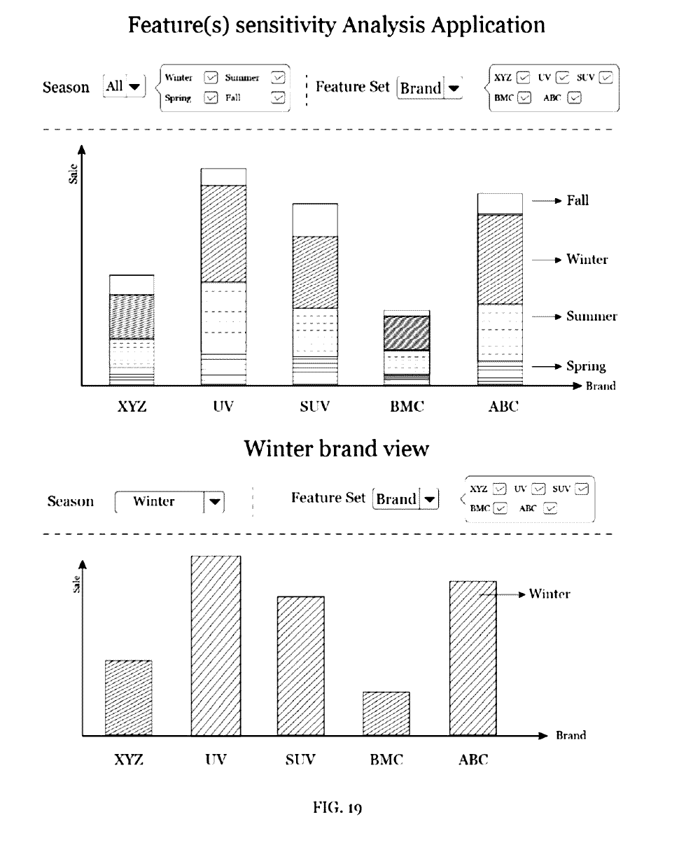

FIG. 19 shows a “Feature(s) sensitivity Analysis Application” For any of the feature selected across all the feature values the choice and predict summation view is presented across all the customers. This shows the relative importance of all the different values of the feature. Brand sensitivity analysis across all product categories is a good example of this. A Retailer selling 5 different brands can get clear ranking of importance and even quantified purchase prescriptions as a summation of all individual choice and predict products across all customers. For this application a single feature set containing a single attribute “brand” is chosen. Affordability ranges are not defined and complete prediction generation process is run.

Two important problems of a predictive system for retailers especially Bric-and-Mortar retailers are cold start problem and frequently changing catalogue problem. Cold start problem refers to problem of finding predictions for a product newly introduced in the catalogue. Frequently changing catalogue problem is because of the fact by the time enough sales history of an item becomes available the item is retired to make room for new items. For SME retailers huge amount of repeated sales history of the same item is almost impossible to obtain. An extreme example of this is one of a kind sellers like jewellers. Where by definition no item can be sold more than once and hence collaborative filtering methods cannot find any recommendations. The problem is compounded in situations where all the items present at any one time period are never repeated after they are sold out. Even if the lesser state of the art collaborative filtering techniques solving “people who bought this also bought these” can find some predicted products, all those products themselves will never be present in the catalog again. Such approaches are of little value in these practical common retailing situations.

Further, for a retail business, affordability, seasonality, frugality and changing preference of customers or evolution is very important. Abstracting these retail entities and mathematical modelling to capture the influence of each of them to construct and populate the Customer×Product rating matrix R is taken. This approach produces much better prediction quality and solves the two problems mentioned. Additional benefits include automated dynamic predictions of continuously changing newer items for existing customer, ability to utilize seasonality, frugality, affordability in an automated manner for backend as well as front end marketing and personalization campaigns.

Further, Unification of Customer Preference Data across all data sources is achieved. A single Choice array records the preference data collected from all the weighted sources and a single Predict is the prediction of future buys of the customer.

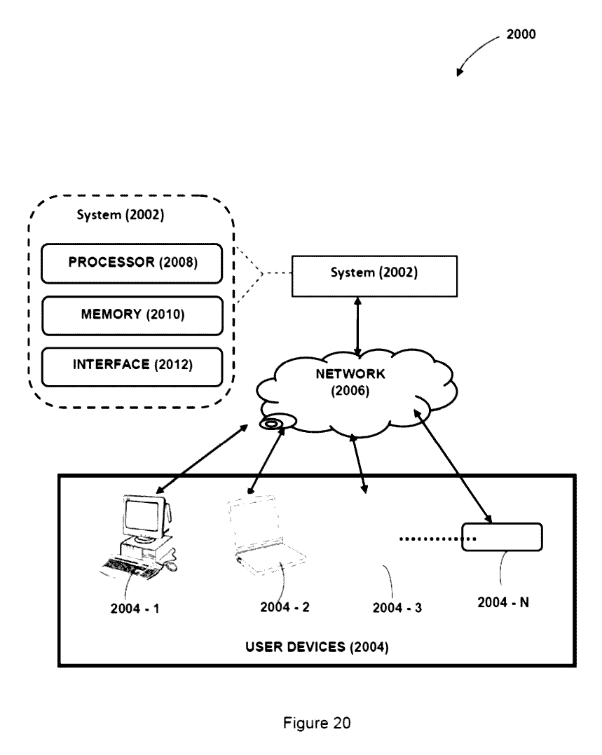

Referring now to FIG. 20, a network implementation 2000 of a system 2002 for generating predictions for customers for a range of products in a retail sector is disclosed. Although the present subject matter is explained considering that the system 2002 is implemented on a server, it may be understood that the system 2002 may also be implemented in a variety of computing systems, such as a laptop computer, a desktop computer, a notebook, a workstation, a mainframe computer, a server, a network server, a cloud-based computing environment and the like. In one implementation, the system 2002 may comprise the cloud-based computing environment in which the user may operate individual computing systems configured to execute remotely located applications. It will be understood that the system 2002 may be accessed by multiple users through one or more user devices 2004-1, 2004-2 . . . 2004-N, collectively referred to as user 2004 hereinafter, or applications residing on the user devices 2004. Examples of the user devices 2004 may include, but are not limited to, a portable computer, a personal digital assistant, a handheld device, and a workstation. The user devices 2004 are communicatively coupled to the system 2002 through a network 2006.

In one implementation, the network 2006 may be a wireless network, a wired network or a combination thereof. The network 2006 can be implemented as one of the different types of networks, such as intranet, local area network (LAN), wide area network (WAN), the internet, and the like. The network 2006 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 2006 may include a variety of network devices, including routers, bridges, servers, computing devices, storage devices, and the like.

The system 2002 is illustrated in accordance with an embodiment of the present disclosure. In one embodiment, the system 2002 may include at least one processor 2008, a memory 2010, and an input/output (I/O) interface 2012. The at least one processor 2008 may be implemented as one or more microprocessors, microcomputers, microcontrollers, digital signal processors, central processing units, state machines, logic circuitries, and/or any devices that manipulate signals based on operational instructions. Among other capabilities, the at least one processor 2008 is configured to fetch and execute computer-readable instructions stored in the memory 2010.

The I/O interface 2012 may include a variety of software and hardware interfaces, for example, a web interface, a graphical user interface, and the like. The I/O interface 2012 may allow the system 2002 to interact with the user directly or through the user devices 2004 also hereinafter referred to as client devices 2004. Further, the I/O interface 2012 may enable the system 2002 to communicate with other computing devices, such as web servers and external data servers (not shown). The I/O interface 2012 can facilitate multiple communications within a wide variety of networks and protocol types, including wired networks, for example, LAN, cable, etc., and wireless networks, such as WLAN, cellular, or satellite. The interface 2012 may include one or more ports for connecting a number of devices to one another or to another server.

The memory 2010 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, at first, a user may use the client devices 2004 to access the system 2002 via the I/O interface 2012. The user may register them using the I/O interface 2012 in order to use the system 2002.

I/we claim:

1. A method for generating predictions for customers for a range of products in a retail sector, the method comprising:
classifying a product based upon exact values of a decision making feature set to generate a product buy point, wherein the product buy point is stored as a record;
associating the product to the product buy point and to a number of affordability price ranges;
partitioning the product bus point into as many affordability partitioned product buy points as the number of affordability price ranges;
computing a seasonality vector and a frugality vector for the product and for the product buy point based upon an actual sale records of the product, wherein the seasonality vector is indicative of a time frame or seasons, and wherein the frugality vector is a discount constraint on the product or customer;
receiving customers preference data for the product from a plurality of sources;
unifying the customer preference data of different importance from the plurality of sources;
generating a customer product matrix based upon the unified customer preference data of the customers and the affordability partitioned product buy points wherein the customer product matrix is generated by applying an evolution parameter and a frugality fraction on the unified customer preference data, wherein the evolution parameter is indicative of a customer's changing buying behavior over a period of time; and
applying a singular vector decomposition technique and a reconstitution technique to the customer product matrix to obtain non zero values of the customer product matrix, wherein the non zero values are indicative of positive predictions for the partitioned buy points for a given customer in the customer product matrix.

2. The method of claim 1, wherein the customer product matrix comprises an interest factor indicative of products being added in a shopping cart, or being browsed, or being actually bought by a customer.

3. The method of claim 1, wherein the decision making feature set comprise of different features comprising brand, a price, a material, a style, a color, and a pattern.

4. The method of claim 1, further comprising receiving information of the customer, wherein the information comprises an age group, an occupation, a culture, a tradition, and a geographical area of residence.

5. The method of claim 1, wherein the customer product matrix further comprises a set of affordability partitioned product buy points, wherein the set partitioned buy points are indicative of all products associated with the price ranges of corresponding product buy points.

6. The method of claim 1, wherein the plurality of sources comprises sales history of physical sources, online sales, browsing history of products, and shopping cart items.

7. A system (2002) for generating predictions for customers for a range of products in a retail sector, the system comprises:
a memory (2010); and
a processor (2008) coupled to the memory, wherein the processor executes programmed instructions stored in the memory to:
classify a product based upon exact values of a decision making feature set to generate a product buy point, wherein the product buy point is stored as a record;
associate the product to the product buy point and to a number of affordability price ranges;
partition the product buy point into as many affordability partitioned product buy points as the number of affordability price ranges;
compute a seasonality vector and a frugality vector for the product and for the product buy point based upon an actual sale records of the product, wherein the seasonality vector is indicative of a time frame or seasons, and wherein the frugality vector is a discount constraint on the product or customer;
receive customers preference data for the product from a plurality of sources;
unify the customer preference data of different importance from the plurality of sources;
generate a customer product matrix based upon the unified customer preference data of the customers and the affordability partitioned product buy points, wherein the customer product matrix is generated by applying an evolution parameter and a frugality fraction on the unified customer preference data, wherein the evolution parameter is indicative of a customer's changing buying behavior over a period of time; and
apply a singular vector decomposition technique and a reconstitution technique to the customer product matrix to obtain non zero values of the customer product matrix, wherein the non-zero values are indicative of positive predictions for the partitioned buy points for a given customer in the customer product matrix.

8. The system of claim 7, wherein the customer product matrix comprises an interest factor indicative of products being added in a shopping cart, or being browsed, or being actually bought by a customer.

9. The system of claim 7, wherein the decision making feature set comprise of different features comprising brand, a price, a material, a style, a color, and a pattern.

10. The system of claim 7, further comprising receiving information of the customer, wherein the information comprises an age group, an occupation, a culture, a tradition, and a geographical area of residence.

11. The system of claim 7, wherein the customer product matrix further comprises a set of affordability partitioned product buy points, wherein the set partitioned buy points are indicative of all products associated with the price ranges of corresponding product buy points.

12. The system of claim 7, wherein the plurality of sources comprises sales history of physical sources, online sales, browsing history of products, and shopping cart items.

13. A non-transitory computer readable medium embodying a program executable in a computing device for generating predictions for customers for a range of products in a retail sector, the program comprising:
a program code for classifying a product based upon exact values of a decision making feature set to generate a product buy point, wherein the product buy point is stored as a record;
a program code for associating the product to the product buy point and to a number of affordability price ranges;
a program code for partitioning the product buy point into as man affordability partitioned product buy points as the number of affordability price ranges;
a program code for computing a seasonality vector and a frugality vector for the product and for the product buy point based upon an actual sale records of the product, wherein the seasonality vector is indicative of a time frame or seasons, and wherein the frugality vector is a discount constraint on the product or customer;
a program code for receiving customers preference data for the product from a plurality of sources;
a program code for unifying the customer preference data of different importance from the plurality of sources;
a program code for generating a customer product matrix based upon the unified customer preference data of the customers and the affordability partitioned product buy points, wherein the customer product matrix is generated by applying an evolution parameter and a frugality fraction on the unified customer preference data, wherein the evolution parameter is indicative of a customer's changing buying behavior over a period of time; and
a program code for applying a singular vector decomposition technique and a reconstitution technique to the customer product matrix to obtain non zero values of the customer product matrix, wherein the non-zero values are indicative of positive predictions for the partitioned buy points for a given customer in the customer product matrix.
